(19) United States
(12) Patent Application Publication
(10) Pub. No.: US 2025/0220427 A1
(43) Pub. Date: Jul. 3, 2025

(54) SYSTEM AND METHOD FOR AUTHENTICATING USER ACCESS TO A WIRELESS NETWORK

(71) Applicant: 5321 Innovation Labs LLC, Franklin, MA (US)

(72) Inventors: Edward W. Neipris, Wrentham, MA (US); David R. Doiron, Franklin, MA (US); Tyler Richard Nesper, Denver, CO (US); Yassine El Andaloussi, North Andover, MA (US)

(21) Appl. No.: 18/990,142

(22) Filed: Dec. 20, 2024

Related U.S. Application Data
(60) Provisional application No. 63/616,888, filed on Jan. 2, 2024.

(51) Int. Cl. H04W 12/069; H04W 84/12

(52) U.S. Cl. CPC H04W 12/069; H04W 84/12

(57) ABSTRACT

A system and method for authenticating user access to a wireless network in which the wireless network is configured to support the use of individual pre-shared keys (PSKs) for verification even when operating under the Wi-Fi Protected Access Version 3 (WPA3) security protocol. Using the Wi-Fi Protected Access Version 2 (WPA2) security standard, the wireless network is designed to compile a lookup table linking the Media Access Control (MAC) address of a wireless device with a user-provided PSK. Subsequently, the network is able to authenticate the device under the WPA3 standard by extracting the user PSK from the lookup table using its MAC address and, in turn, performing the Simultaneous Authentication of Equals (SAE) secure key exchange protocol. Accordingly, wireless devices previously authorized for access under the WPA2 standard using a PSK can be efficiently transitioned for connection to the same network using the same PSK under the WPA3 standard.

### CROSS-REFERENCE TO RELATED APPLICATIONS

The present invention claims the benefit under 35 U.S.C. 119 (e) to U.S. Provisional Patent Application No. 63/616,888, which was filed on Jan. 2, 2024, in the names of Edward W. Neipris et al., the disclosure of which is incorporated herein by reference.

### FIELD OF THE INVENTION

The present invention relates generally to the field of wireless networks and, more particularly, to security protocols for wireless networks.

### BACKGROUND OF THE INVENTION

Wireless networks are designed to provide selected wireless devices with regulated access to a wide array of network services, such as internet access, and network resources, such as network printers. Commonly, a wireless network includes, inter alia, (i) a router for establishing a network connection, and (ii) at least one wireless access point (WAP), or access point (AP), in communication with the router for providing wireless devices with regulated access to the network. In larger network environments, such as apartment complexes and enterprise businesses, a plurality of interconnected access points are optimally arranged to expand the wireless range of a network.

Typically, networks are automatically identified by any wirelessly enabled device that is located within range. To help a user differentiate between multiple available networks within close range, each network is ordinarily provided with a unique network name, or service set identifier (SSID). A single access point can support a number of distinct networks by broadcasting multiple SSIDs, essentially creating separate wireless networks with different levels of access for various users.

Wireless network security protocols are encryption standards implemented by wireless networks to ensure that (i) network access is restricted to authorized users, and (ii) communications between network devices are suitably encrypted, thereby rendering the network safer and more secure. As a result, even if an unauthorized network device was able to incept data transmitted within the network, the encrypted data would be extremely difficult to decode.

Wi-Fi Protected Access Version 2, or WPA2, is a wireless network security standard that is predominantly utilized to authenticate network access and encrypt network communications. Wireless networks operating under the WPA2 security standard rely upon the exchanging, or sharing, of a pre-shared key (PSK) between user equipment (UE) and an access point through a secure transmission channel in order to authenticate the user equipment and, in turn, encrypt all communication data.

Specifically, when an electronic device attempts to join a network through a wireless AP, the user is typically required to log into the network using the network SSID and a user-provided password. The SSID and password are then utilized to create a personal PSK in the form of a long string of alphanumerical characters. In combination with some additional information, the generated PSK is utilized to effectively create an encryption key.

Under the WPA2 standard, the UE and AP engage in a handshake process, or exchange, in which complex numerical data strings are transmitted therebetween. An encryption dictionary matching process is applied to the transmitted data strings in order to identify the PSK. In this manner, the PSK remains effectively hidden and protected when authenticating the user device. Once network connection is achieved, the encryption key is utilized to encrypt all future data transmitted between the client device and the access point.

Although well-known and widely utilized for decades as the primary security standard for wireless networks, WPA2 has been found to be vulnerable to breaches in security. In particular, offline dictionary attacks are often applied to intercepted network data in order to retrieve, and subsequently reinstall, the pre-shared key in order to enable unauthorized parties to decrypt future communications.

In response, Wi-Fi Protected Access Version 3, or WPA3, has been developed and implemented as a novel wireless network security standard that is intended, in time, to replace WPA2. The WPA3 security standard utilizes a longer encryption key to provide more robust password-based authentication, thereby strengthening the overall security of a wireless network. Additionally, in lieu of the conventional key exchange process, the WPA3 security standard utilizes the Simultaneous Authentication of Equals (SAE) authentication and cryptographic process.

SAE is a password-based authentication protocol by which two network devices (e.g., UE and AP), considered as equals, mutually authenticate each other at the same time as part of a key exchange process. Because the encryption key exchange process occurs simultaneously between devices, the user password is utilized only to derive a session key and is not directly transmitted between network devices. As a consequence, the user password is resistant to reinstallation (i.e., Dictionary Matching) attacks and thereby more effectively protected.

Although the WPA3 security standard is considered more robust and secure than the WPA2 security standard, user devices previously authorized for access to a network operating under the WPA2 security standard cannot be seamlessly verified for access to the same network after transitioning to the WPA3 security standard. Notably, the personal PSK utilized by a client device when connecting to a network operating under the WPA2 standard cannot be similarly utilized when the network adopts the WPA3 security standard. Continued access using the same PSK is prohibited because the WPA3 security standard utilizes the SAE authentication process, which avoids direct transmission of a PSK, or similar cryptographic key, between network devices as a shield against Dictionary Matching attacks.

Instead, when a wireless network converts from the WPA2 standard to the WPA3 standard, a client is typically required to engage in an entirely new verification process under the WPA3 authentication protocol for each piece of user equipment seeking to obtain access to the network. Because the preliminary stages of this supplemental authentication process are largely manual (e.g., selecting the network SSID and establishing a user password), this requirement when upgrading network security protocols is often found to be an unwanted and time-consuming nuisance for clients, particularly for clients seeking to reuse the same password.

### SUMMARY OF THE INVENTION

In view thereof, it is an object of the present invention to provide a novel system and method for authenticating user access to a wireless network.

It is another object of the present invention to provide a system and method of the type as described above wherein the wireless network utilizes a security protocol for authenticating user access and encrypting network communications.

It is yet another object of the present invention to provide a system and method of the type as described above wherein the wireless network supports both the Wi-Fi Protected Access Version 2 (WPA2) and Wi-Fi Protected Access Version 3 (WPA3) security standards.

It is still another object of the present invention to provide a system and method of the type as described above wherein the wireless network is configured to support the use of individual pre-shared keys (PSKs) for verification.

It is yet still another object of the present invention to provide a system and method of the type as described above wherein the wireless network is configured to automatically convert user equipment authenticated under the WPA2 security protocol using a user-defined PSK to the WPA3 security protocol using the same PSK.

It is another object of the present invention to provide a system and method of the type as described above which is highly secure, inexpensive to implement, and readily scalable.

Accordingly, as one feature of the present invention, there is provided a wireless network authentication system comprising (a) a wireless network configured to support connection using the Wi-Fi Protected Access Version 2 (WPA2) security standard and the Wi-Fi Protected Access Version 3 (WPA3) security standard, the wireless network comprising, (i) an access point for regulating access to the wireless network, and (ii) a database in communication with the access point, the database maintaining a lookup table, and (b) an electronic device in communication with the access point, the electronic device being assigned a unique Media Access Control (MAC) address, (c) wherein the lookup table cross-references the MAC address for the electronic device with a user-provided, pre-shared key (PSK), (d) wherein, if the MAC address for the electronic device is associated with a corresponding PSK in the lookup table, the access point authenticates the electronic device for access to the wireless network under the WPA3 security standard using the PSK.

Various other features and advantages will appear from the description to follow. In the description, reference is made to the accompanying drawings which form a part thereof, and in which is shown by way of illustration, an embodiment for practicing the invention. The embodiment will be described in sufficient detail to enable those skilled in the art to practice the invention, and it is to be understood that other embodiments may be utilized and that structural changes may be made without departing from the scope of the invention. The following detailed description is therefore, not to be taken in a limiting sense, and the scope of the present invention is best defined by the appended claims.

### BRIEF DESCRIPTION OF THE DRAWINGS

In the drawings, wherein like reference numerals represent like parts:

FIG. 1 is a simplified block diagram of a system for authenticating user access to a wireless network, the system being designed according to the teachings of the present invention; and

FIG. 2 is a flow chart depicting a novel process for authenticating user access to a wireless network using the system shown FIG. 1.

### DETAILED DESCRIPTION OF THE INVENTION

### Wireless Network Authentication System 11

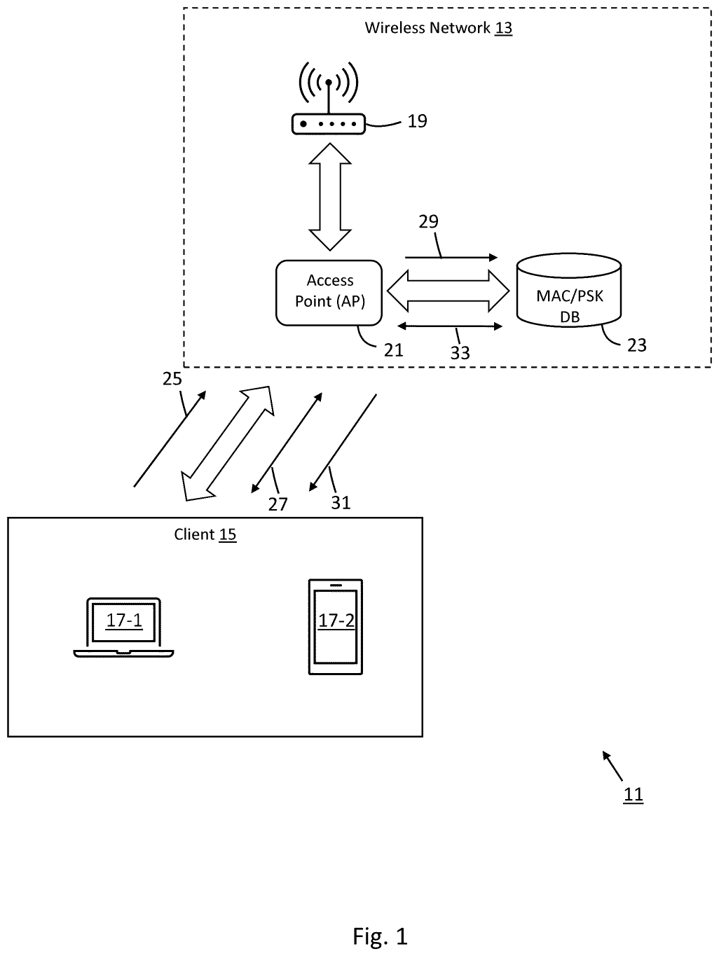

Referring now to FIG. 1, there is shown the basic architecture of a wireless network authentication system designed according to the teachings of the present invention, the authentication system being identified generally by reference numeral 11. As will be explained in detail below, system 11 is uniquely configured to support the use of pre-shared keys (PSKs) in a network utilizing the Wi-Fi Protected Access Version 3 (WPA3) security standard. As a result, electronic devices previously authorized for access to a wireless network under the Wi-Fi Protected Access Version 2 (WPA2) security standard using a pre-shared key can be seamlessly and efficiently transitioned for connection to the same wireless network using the same pre-shared key under the WPA3 security protocol.

As can be seen, system 11 comprises (i) a wireless network 13 that provides selective access to, inter alia, various network services (e.g., internet access) and devices (e.g., printers), and (ii) at least one user, or client, 15 seeking access to wireless network 13. As will be described further in detail below, user validation and subsequent communications between each user 15 and network 13 are regulated by the encryption security standard utilized by wireless network 13. In this manner, data transmitted to and from wireless network 13 remains protected and secure from unauthorized third parties.

For simplicity and ease of illustration, system 11 is shown depicting a single client 15 seeking authorization to a single wireless network 13. However, it is to be understood that, in actuality, system 11 preferably includes a plurality of networks 13, each of which provides a selection of network services and/or devices to a plurality of users 15 under certain access parameters, such as bandwidth and/or time restrictions. Accordingly, it should be noted that the present invention is adapted to be readily scalable to support larger network environments.

Additionally, in the present embodiment, client 15 is shown comprising a pair of electronic devices, or user equipment (UE), 17-1 and 17-2. Each UE 17 represents any wirelessly enabled electronic device. For instance, UE 17-1 is depicted herein as a laptop computer and UE 17-2 is depicted herein as a smartphone. However, it to be understood that the number and/or type of user equipment 17 could be modified without departing from the spirit of the present invention.

As can be appreciated, the specific design and means of user authentication implemented by wireless network 13 are considered novel. Among other things, wireless network 13 is uniquely configured to support the use of PSKs for authentication under the WPA3 security standard. As a result, electronic devices previously verified for connection to a wireless network under the WPA2 standard can be transitioned, with minimal user interaction, to permanently connect to the same network under the WPA3 standard, thereby rendering network communications more secure.

### Wireless Network 13

As referenced above, wireless network 13 is configured to support the utilization of both WPA2 and WPA3 security protocols for authenticating access to user equipment. However, as a primary feature of the present invention, a single, common PSK can be utilized for user equipment verification under both security protocols. As a result, wireless network 13 is designed to convert user equipment 17 previously authenticated under the WPA2 standard to the updated WPA3 standard in a highly automated fashion and with limited manual involvement by user 15. Therefore, wireless network 13 is effectively able to simply and easily convert a network previously operating under the WPA2 standard to the more secure WPA3 standard with limited user disruption.

As will be explained further below, wireless network 13 is configured to support the use of pre-shared keys under the WPA3 security standard. Traditionally, a network operating under the WPA3 security protocol does not support the use of PSKs because the more robust encryption standard does not allow for the transmission of the pre-shared key, even after encryption, from user equipment 17 to wireless network 13 during the initial verification process, as typically required. However, wireless network 13 resolves this technical roadblock by compiling and maintaining a lookup table that links the unique pre-shared key (PSK) for each piece of user equipment 17 with its preassigned Media Access Control (MAC) address. As such, wireless network 13 is able to retrieve the PSK for an electronic device 17 by retrieving its MAC address, thereby circumventing the PSK transmission requirement.

As seen in FIG. 1, wireless network 13 is similar in design to a conventional wireless network in that wireless network comprises (i) a router 19 for establishing network 13, and (ii) at least one wireless access point (WAP), or access point (AP), 21 in communication with router 19. As can be appreciated, network resources provided by router 19 are, in turn, delivered to authorized users 15 via access point 21.

As referenced above, router 19, in combination with additional network devices, is responsible for, inter alia, creating network 13, maintaining a service set identifier (SSID) as a means for network identification by each client 15 within range, and defining the capabilities of the network SSID (e.g., the connection type, authentication method, and encryption method for the network). Although not shown herein, router 19 is preferably in communication with various network services and/or devices for use by authorized clients 15. For instance, router 19 is preferably in communication with an internet service provider (ISP) in order to provide authenticated users with internet access.

In the present example, router 19 is shown defining a single network 13. However, it should be noted that router 19 is not limited to establishing a single network 13. Rather, it is to be understood that router 19 may handle multiple distinct networks, each with its own set of access parameters and use restrictions.

Access point 21 is a network device that enables authenticated electronic devices 17 to connect to network 13 and, in turn, utilize available network devices and services. In order to implement the novel user authentication protocol of the present invention, AP 21 is configured to support network communications under both the WPA2 and WPA3 security standards, as will be explained further below.

Although a single access point 21 is represented herein, it is to be understood that network 13 could be provided with a plurality of interconnected access points 21. By arranging APs 21 in an optimal configuration, the range of network 13 could be significantly expanded. Increasing network range is particularly important in larger network environments, such as apartment complexes and other similar types of large-scale, multi-family, facilities.

Wireless network 13 differs from a conventional wireless network in that wireless network 13 maintains a database 23 in communication with access point 21. As referenced briefly above and as will be explained further below, database 23 maintains a lookup table that links the unique pre-shared key (PSK) associated with each piece of user equipment 17 with its designated Media Access Control (MAC) address.

Although the present invention relies upon a MAC address to a piece of user equipment 17, it should be noted that alternative types of unique identifiers could be used in place thereof to recognize a device. It is only required that the unique identifier be available for retrieval by access point 21 during the authentication process.

### User Authentication Process 111

As referenced above, system 11 is uniquely designed to implement a novel user authentication process for access to wireless network 13, the process being identified generally herein using reference numeral 111. As will be explained in detail below, process 111 supports wireless connection to network 13 using both WPA2 and WPA3 security standards and, in addition, seamlessly and automatically transitions user equipment 17 that was previously authenticated to access wireless network 13 under the WPA2 security standard to the enhanced WPA3 security standard. As a result, method 111 helps update the active communication standard for a wireless network from the WPA2 protocol to WPA3 protocol using minimal direct involvement from user 15, which is highly desirable.

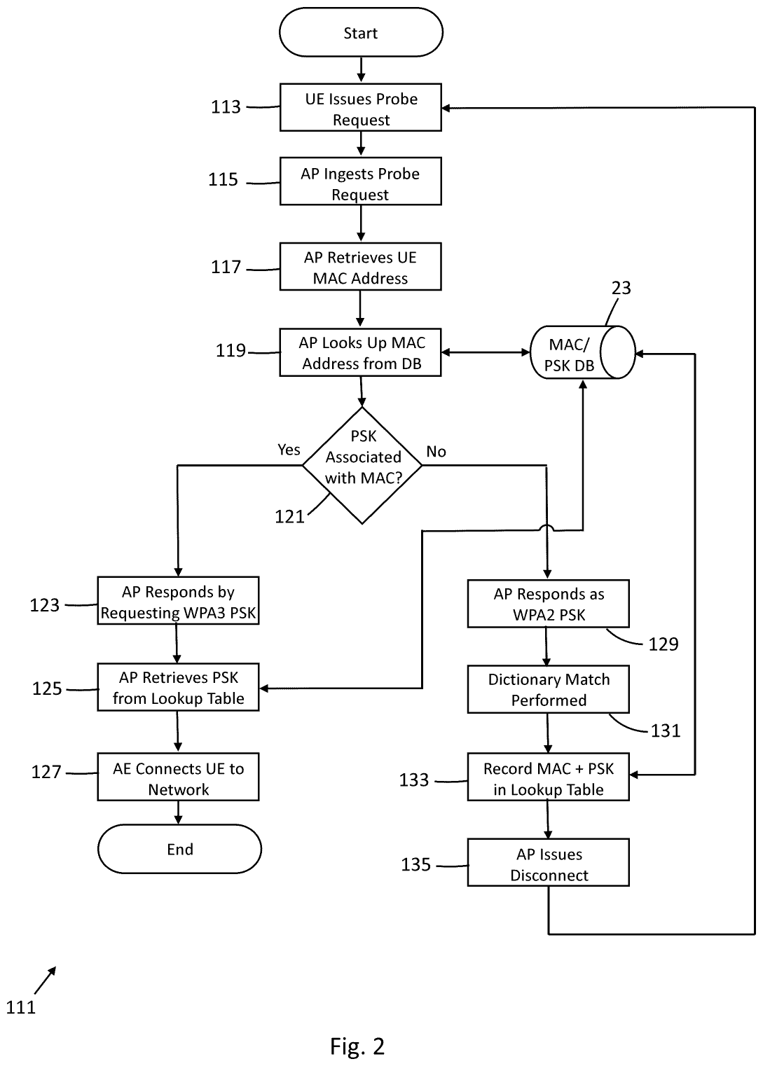

Referring now to FIG. 2, there is shown a simplified flow chart of user authentication process, or method, 111. As can be seen, when attempting to connect to wireless network 13, user equipment 17 issues a probe request, the probe request being represented generally as step 113 in FIG. 2 and by arrow 25 in FIG. 1.

The probe request sent by user equipment 17 is sent to all available APs 21 within range. As part of step 113, user equipment 17 requests the name (i.e., the SSID) of all network 13 available through each AP 21. Additionally, user equipment 17 requests that each AP 21 provide the capabilities of each associated network 13, which may include, but is not limited to, the network connection type, the method of user authentication, and the active protocol of wireless encryption.

Upon receiving the probe request, an access point 21 associated with an available network 13 ingests the probe request, as shown in step 115. Thereafter, access point 21 attempts to retrieve the Media Access Control (MAC) address from the specific piece of user equipment 17, the MAC address retrieval being represented generally as step 117 in FIG. 2 and by arrow 27 in FIG. 1.

Having received the MAC address from user equipment 17, access point 21 performs a lookup of the MAC address for user equipment 17 in the MAC/PSK lookup table maintained by database 23, as represented generally as step 119 in FIG. 2 and as arrow 29 in FIG. 1. Lookup step 119 can be performed using various techniques including, but not limited to, a direct database lookup, an Application Programming Interface (API) request, or a Remote Authentication Dial-In User Service (RADIUS) access request.

As part of step 121, access point 21 determines whether there is currently a valid pre-shared key (PSK) established under the WPA3 security protocol associated with the MAC address for the user equipment 17. In other words, access point 21 determines whether user equipment 17 previously engaged in the authentication process for connection to network 13 under the WPA3 security standard.

If the piece of user equipment 17 has a pre-shared key (PSK) already associated with its MAC address in MAC/PSK database 23, access point 21 will respond to the probe request from UE 17 using the WPA3 security standard, as represented as step 123 in FIG. 2 and by arrow 31 in FIG. 1. More specifically, access point 21 informs user equipment 17 that wireless network 13 is capable of, and expecting, WPA3 personal authentication and encryption as part of the connection process. Accordingly, in response, client 15 is required to wirelessly connect to network 13 under the WPA3 security standard.

Thereafter, the access point 21 will retrieve the PSK associated with user equipment 17 from the MAC/PSK lookup table using the identified MAC address, as represented as step 125 in FIG. 2 and by arrow 33 in FIG. 1. It should be noted that the retrieval of the PSK from the MAC/PSK lookup table can be performed utilizing any of the techniques referenced above in connection with lookup step 119.

With the PSK provided to access point 21, both user equipment 17 and access point 21 are able to independently possess the same personal PSK (i.e., without any direct transmission of an encrypted PSK therebetween). Therefore, using the PSK, user authentication can be implemented under the WPA3 security protocol using the Simultaneous Authentication of Equals (SAE) cryptographic process. As part of the SAE process, two devices (i.e., UE 17 and AP 21), considered as equals, can achieve mutual authentication by performing a secure key exchange simultaneously on both sides using the same PSK. As a result, user authentication can be achieved using the SAE process without directly exposing the PSK, thereby rendering the network more secure and better protected.

Implementation of the aforementioned SAE mechanism yields the necessary authentication and encryption that is required to connect user equipment 17 to wireless network 13 under the WPA3 protocol, this connection step being represented generally as step 127 in FIG. 2. With user equipment 17 now successfully connected to wireless network 13, user authentication process 111 terminates.

Returning back to determining step 121, if the piece of user equipment 17 does not have a PSK associated with its MAC address in MAC/PSK database 23 (e.g., due to no previous connection with network 13), access point 21 will respond to the probe request from UE 17 using the WPA2 security standard, as represented as step 129 in FIG. 2. Accordingly, as part of response step 129, access point 21 requests that user equipment 17 connect to the SSID for network 13 utilizing a user-provided, WPA2-based, encrypted PSK.

In turn, access point 21 sends the information provided from UE 17 into a system capable of providing PSK dictionary matching in order to retrieve, or decrypt, the PSK and authenticate user access, this dictionary matching step being represented generally by reference numeral 131. This dictionary matching system could be in the form of, inter alia, a cloud-based PSK dictionary matching system, a RADIUS server, or an access point in local mode which is configured to implement a dictionary matching system.

Once the user-provided PSK is positively decrypted in dictionary matching step 131, the MAC address of UE 17 and the identified PSK are linked together and recorded in the lookup data table maintained in MAC/PSK database 23, this recordation step being represented generally by reference numeral 133. As a result, any future lookup required as part of probe request step 113 of user authentication process 111 will notify access point 21 that a match has been found and that the MAC address of connecting device 17 has been entered into the lookup table maintained in MAC/PSK database 23.

Following recordation step 133, access point 21 disconnects user equipment 17 from network 13 under the WPA2 security protocol as part of a disconnection step 135. Preferably, notification of disconnection can be delivered to the user by, but not limited to, a change of authority message or a device disconnect message.

After the access point 21 issues the disconnect message to connecting device 17, user authentication step 111 returns to probe request step 113, as shown in FIG. 2. This time, however, when access point 21 performs lookup step 119 to determine whether the MAC address of UE 17 is associated with a known PSK, it will identify that a PSK is already associated with the MAC address. Therefore, access point 21 will respond to the probe request by informing connecting device 17 that network 13 is now capable of, and expecting, user authentication and encryption under the WPA3 standard, as set forth in step 123.

As a feature of the present invention, the aforementioned process supports the use of pre-shared keys as means for authorizing access to a Wi-Fi network which utilizes the WPA3 standard. Additionally, the aforementioned process enables user equipment that is already authorized for access to a network operating under the WPA2 security standard to automatically retain verification as the network transitions to the more robust WPA3 security standard. This enables network users to keep existing passwords and avoid manual re-initiation of the verification processes when a network transitions from the WPA2 security standard to the WPA3 security standard, as is typically required.

The invention described in detail above is intended to be merely exemplary and those skilled in the art shall be able to make numerous variations and modifications to it without departing from the spirit of the present invention. All such variations and modifications are intended to be within the scope of the present invention as defined in the appended claims.

What is claimed is:

1. A wireless network authentication system comprising:
(a) a wireless network configured to support connection using the Wi-Fi Protected Access Version 2 (WPA2) security standard and the Wi-Fi Protected Access Version 3 (WPA3) security standard, the wireless network comprising,
(i) an access point for regulating access to the wireless network, and
(ii) a database in communication with the access point, the database maintaining a lookup table; and
(b) an electronic device in communication with the access point, the electronic device being assigned a unique Media Access Control (MAC) address;
(c) wherein the lookup table cross-references the MAC address for the electronic device with a user-provided, pre-shared key (PSK);
(d) wherein, if the MAC address for the electronic device is associated with a corresponding PSK in the lookup table, the access point authenticates the electronic device for access to the wireless network under the WPA3 security standard using the PSK.

2. The system as claimed in claim 1 wherein the wireless network further comprising a router for establishing the wireless network, the router being in communication with the access point.

3. The system as claimed in claim 1 wherein the access point is configured to retrieve the MAC address from the electronic device.

4. The system as claimed in claim 3 wherein the access point requests that the electronic device provide a PSK while connected to the wireless network under the WPA2 security standard if no PSK is associated with the MAC address listed in the lookup table.

5. The system as claimed in claim 4 wherein dictionary matching is applied to the PSK to authenticate the electronic device attempting to connect to the wireless network under the WPA2 security standard.

6. The system as claimed in claim 5 wherein the access point is configured to disconnect the electronic device from the wireless network after receiving the user-provided PSK.

7. The system as claimed in claim 3 wherein the access point is configured to retrieve the PSK associated with the MAC address listed in the lookup table.

8. The system as claimed in claim 7 wherein the access point is configured to retrieve the PSK associated with the MAC address listed in the lookup table using one of a direct database lookup, an Application Programming Interface (API) request, and a Remote Authentication Dial-In User Service (RADIUS) access request.

9. The system as claimed in claim 7 wherein the access point authenticates the electronic device for access to the wireless network under the WPA3 security standard by performing the Simultaneous Authentication of Equals (SAE) secure key exchange protocol using the PSK associated with the MAC address in the lookup table.
